(19) United States
(12) Patent Application Publication
(10) Pub. No.: US 2019/0087890 A1
(43) Pub. Date: Mar. 21, 2019

(54) PURCHASE GUIDE INFORMATION PROVIDING SYSTEM WITH INTELLIGENT SELECTING FUNCTIONS MOUNTED AND METHOD THEREFOR

(71) Applicant: Ki-won Nam, Seoul (KR)

(72) Inventor: Ki-won Nam, Seoul (KR)

(21) Appl. No.: 16/086,971

(22) PCT Filed: Mar. 20, 2017
(86) PCT No.: PCT/KR2017/002973

§ 371 Date: Sep. 20, 2018

(30) Foreign Application Priority Data
Mar. 21, 2016 (KR) 10-2016-0033232

(51) Int. Cl. G06Q 30/06; G06Q 30/02

(52) U.S. Cl. CPC G06Q 30/0643; G06Q 30/0629; G06Q 30/0239; G06Q 30/0631; G06Q 30/0639

(57) ABSTRACT

The present invention relates to a purchase guide information providing system with intelligent selecting functions mounted and a method thereof. The present invention has an object to provide a purchase guide information providing system with intelligent selecting functions mounted and a method thereof, wherein if a consumer selects a predetermined browsing item which is a minimum condition, a predetermined number of pieces of company information are automatically extracted in descending order of total points of scores assigned to the browsing item and are provided to the consumer, and if a predetermined number of pieces of company information is browsed from among the extracted company information, a specific company of the browsed companies is recommended by a server, and if a product of the specific company is purchased by the consumer, browsing incentives pre-assigned by each of the browsed companies and purchase incentives pre-assigned by a selling company are processed so as to be provided to the consumer, such that great benefits are offered to the consumer over input time spent.

### TECHNICAL FIELD

The present invention relates to a purchase guide information providing system mounted with intelligent selecting functions and a method thereof, and more particularly, to a purchase guide information providing system mounted with intelligent selecting functions and a method thereof, wherein if a consumer selects a predetermined browsing item which is a minimum condition, a predetermined number of pieces of company information are automatically extracted in descending order of total point values of scores assigned to the browsing item and are provided to the consumer, and if a predetermined number of pieces of company information is browsed from among the extracted company information, a specific company of the browsed companies is recommended by a server, and if a product of the specific company is purchased by the consumer, browsing incentives pre-assigned by each of the browsed companies and purchase incentives pre-assigned by a selling company are processed so as to be provided to the consumer, such that great benefits are offered to the consumer over the input time spent.

### BACKGROUND ART

As well known in the art, in accordance with recent development of information communication technology, a technology for information service that provides information on various fields by wide area data communication network in real time to multiple subscribers through at least one or more host servers has been actively developed.

Based on the technology, recently, a peripheral technology such as a cache memory expansion technology for more rapidly providing accurate information to a subscriber, and an information sorting and compression technology for more conveniently accessing taste and preference of the subscriber have been developed. Accordingly, development of various contents and solutions therethrough is also accelerated.

In this regard, the technology development is directed at creating profit. On the basis of this trend, as a commerce market is moving to an electronic commerce market, various advertisement methods and product selling methods have been introduced in the market.

As such, as competition for advertising and selling products intensifies, conditions for advertising and selling more products are pouring into the market. However, even if it is assumed that a user has made a predetermined benefit by carefully comparing each condition and purchasing a product, in this case, the benefit does not consider the wasted time of the user.

On the other hand, when the user selects the purchase of the product without considering conditions of advertisement or sale of products at all, this results in a situation in which the user gives up the predetermined benefit that the user can obtain. Therefore, also in this situation, there is a dilemma that the user will suffer a loss.

Therefore, it is necessary to find a way to obtain a great benefit in comparison with the time spent by the user between the time of the user constituting the inverse relationship and the benefit obtained by the user.

Meanwhile, due to the various conditions of advertisement or sale of products, there are too many pieces of information that consumers should consider at the time of purchase, such that such a purchasing environment is another variable which causes indecisiveness in a purchase.

### DISCLOSURE

### Technical Problem

In consideration of the above-mentioned circumstances, it is an object of the present invention to provide a purchase guide information providing system mounted with intelligent selecting functions and a method thereof, wherein if a consumer selects a predetermined browsing item which is a minimum condition, a predetermined number of pieces of company information are automatically extracted in descending order of total point values of scores assigned to the browsing item and are provided to the consumer, and if a predetermined number of pieces of company information is browsed from among the extracted company information, a specific company of the browsed companies is recommended by a server, and if a product of the specific company is purchased by the consumer, browsing incentives pre-assigned by each of the browsed companies and purchase incentives pre-assigned by a selling company are processed so as to be provided to the consumer, such that great benefits are offered to the consumer over the input time spent.

### Technical Solution

To achieve the above-described object, according to an aspect of the present invention, there is provided a purchase guide information providing system mounted with intelligent selecting functions, the system including: a purchase guide information management server 20 which includes: a sale information extraction unit 24 configured to, when receiving a browsing item selection signal from a user terminal 2, extract predetermined browsing target group information 5 that meets a preset extraction condition to transmit the extracted information to the user terminal 2; and a controller 40 configured to receive a browsing signal for specific companies from the user terminal 2, recommend a predetermined company among browsing companies based on a preset selection condition, and when a purchase confirmation signal for any one company of the recommended companies is generated, provide a browsing incentive and a purchase incentive to a user through the user terminal.

Preferably, the browsing target group information 5 is formed by calculating scores of browsing items for each company, and extracting a predetermined number of pieces of company information in descending order from a company having a large total point value, by the purchase guide information management server.

Preferably, the user terminal 2 includes an automatic array controller 8 installed therein to sort and array the browsing target group information 5 received from the purchase guide information management server 20.

Preferably, the browsing target group information 5 is information in which a plurality of pieces of company information including sale information 10, browsing incentive information 12, and purchase incentive information 14 are sorted.

Preferably, the purchase guide information management server 20 includes an array position value providing unit 22 configured to provide array position values of information included in the browsing target group information 5.

Preferably, the purchase guide information management server 20 further includes: a sale information registration unit 28 configured to register the sale information 10, the browsing incentive information 12, and the purchase incentive information 14 by a seller; and an entire target group DB 26 configured to store entire extraction target group information including the sale information 10, the browsing incentive information 12, and the purchase incentive information 14.

Preferably, the browsing items are randomly arrayed, or are arrayed by industry or by an order of distance, or by a size of incentive or an event nominal value in descending order, and include information on newly and/or previously opened companies.

Preferably, the purchase guide information management server 20 further includes: a browsing item selection unit 32 configured to receive a selection signal of at least one or more of browsing items selected by the user among entire browsing items; and a target score calculation unit 30 configured to extract a plurality of pieces of target information corresponding to the browsing items selected by the user from the entire target group DB6, and calculate scores assigned to each target information in order to further select a part of the pieces of the extracted target information.

Preferably, the user terminal 2 includes a key input unit 34 configured to generate a selection signal for browsing company information and a selection signal for purchasing a product, and generate a position designation signal for requesting extraction of companies in an order of distance to a specific point; and a GPS module 36 configured to automatically determine a current position of the user.

Preferably, the purchase guide information management server 20 is configured to recommend a plurality of companies to the user terminal 2.

Preferably, the purchase guide information management server 20 is configured to provide browsing information of the user on the company information to a company terminal 3.

Preferably, the purchase guide information management server 20 is configured to transmit recommendation information of the company for the user, and preliminary purchase information of the user on the company information to a company terminal 3

Preferably, when receiving a prepayment signal from a purchase guide application 4, the purchase guide information management server 20 is configured to provide a browsing incentive and a purchase incentive to the user through the user terminal; and the purchase guide information management server 20 is configured to transmit company information, product information, and payment information, which are prepayment targets, as identification information that can be determined by the company, to the purchase guide application 4.

Preferably, the purchase guide information management server 20 is configured to receive information on a user who has purchased a product from a company terminal 3 and provide a browsing incentive and a purchase incentive to the user.

Preferably, the purchase guide information management server 20 is configured, when receiving a company re-recommendation request signal from a user through the user terminal 2, to impose a penalty on the user.

Preferably, when receiving a company re-recommendation request signal from the user terminal 2, the purchase guide information management server 20 again forms the browsing target group information 5 so that the user further browses the same number of companies as the number of the recommended companies.

Preferably, the controller 40 processes so that at least one newly and/or previously opened company is included in the recommended companies to be provided to the user through the user terminal.

Preferably, the purchase guide information management server 20 receives number information and setting information on the company information to be included in the browsing target group information 5 from a purchase guide application 4, and registers the received information by matching with a user identification number.

Preferably, the purchase guide information management server 20 is set so as to limit the number of pieces of company information providing the browsing incentive to the user.

Preferably, the sale information 10 is information hyperlinked so as to receive detailed sale information from the purchase guide information management server 20.

Preferably, the sale information registration unit 28 processes so as to further register conditional and additional incentive information on an immediate purchase in which a user purchases a product without browsing other companies.

According to another aspect of the present invention, there is provided a method of providing purchase guide information with intelligent selecting functions, the method including the steps of: a) driving a purchase guide application 4 installed in a user terminal 2; b) receiving browsing item selection information from the user terminal 2, by the purchase guide information management server 20; c) extracting browsing target group information 5 that meets an extraction condition to provide the extracted information to the user terminal 2, by the purchase guide information management server 20; d) receiving a browsing signal for a predetermined number of the pieces of the browsing target group information 5, by the purchase guide information management server 20; e) recommending a predetermined company that meets the recommendation condition among the company information browsed by a user, by the purchase guide information management server 20; and f) when receiving a purchase confirmation signal of the user for the company, providing a browsing incentive and a purchase incentive to the user, by the purchase guide information management server 20.

Preferably, the method further includes: before the step a), receiving sale information 10, browsing incentive information, and purchase incentive information from a plurality of companies, by the purchase guide information management server 20.

Preferably, the method further includes: before the step a), assigning and registering scores for each item of a plurality of companies, by the purchase guide information management server 20.

Preferably, the method further includes: before the step a), setting so as to limit the number of companies to which the browsing incentive is assigned, by the purchase guide information management server 20; and in the step f), calculating the browsing incentive by reflecting the limited number of the companies, by the purchase guide information management server 20.

Preferably, the method further includes: before the step a), separately registering an immediate purchase incentive to be provided to the user at the time of a conditional purchase in which the user purchases a product without browsing other companies, by the purchase guide information management server 20.

Preferably, the step e) further includes: when receiving a company re-recommendation request signal from the user terminal 2, imposing a penalty on the user, by the purchase guide information management server 20.

Preferably, wherein the step e) includes: when receiving a company re-recommendation request signal from the user terminal 2, recommending a browsing company except for the recommended companies among the browsing companies of the user, by the purchase guide information management server 20.

Preferably, the step f) provides the browsing incentive and the purchase incentive to the user at the time of confirming a preliminary purchase or a prepurchase of the user, or confirming a purchase of the user in the company, by the purchase guide information management server 20.

Preferably, the method further includes: after the step f), providing, to a company terminal 3, information on a frequency of exposure of the company information included in the browsing target group information 5, information on what user has browsed the company information, and information on a frequency of recommendation of company information to the user, by the purchase guide information management server 20.

### Advantageous Effects

In accordance with the purchase guide information providing system mounted with intelligent selecting functions and the method thereof according to the present invention, it is possible to recommend a company having the most favorable condition to the user who takes the least amount of time, and in this process, recommend a small number of companies by compressing the results. Thus, a user who has to spend a lot of time for purchasing decisions, or who inevitably has to spend a lot of time to find the most favorable condition may make a purchase decision in a very efficient and convenient manner. In addition, since the sellers may intensively use marketing costs on the user who actually makes the purchase, it is possible to obtain marketing effects greater than ever before.

### DESCRIPTION OF DRAWINGS

FIG. 1 is a diagram illustrating a configuration of a purchase guide information providing system mounted with intelligent selecting functions according to an embodiment of the present invention.

FIG. 2 is a diagram illustrating a state in which company information is registered through the purchase guide information providing system mounted with intelligent selecting functions according to the embodiment of the present invention.

FIG. 3 is a diagram illustrating a state of registering and processing browsing items included in the purchase guide information providing system mounted with intelligent selecting functions according to the embodiment of the present invention.

FIG. 4 is a diagram illustrating a state in which scores to be extracted are calculated through the purchase guide information providing system mounted with intelligent selecting functions according to the embodiment of the present invention.

FIG. 5 is a diagram illustrating a state of processing information in the purchase guide information providing system mounted with intelligent selecting functions according to the embodiment of the present invention.

FIG. 6 is a diagram illustrating a state of processing an immediate purchase through the purchase guide information providing system mounted with intelligent selecting functions according to the embodiment of the present invention.

FIG. 7 is a diagram illustrating a state of processing a re-recommendation request through the purchase guide information providing system mounted with intelligent selecting functions according to the embodiment of the present invention.

### BEST MODE

Hereinafter, the present invention will be described in detail with reference to the drawings.

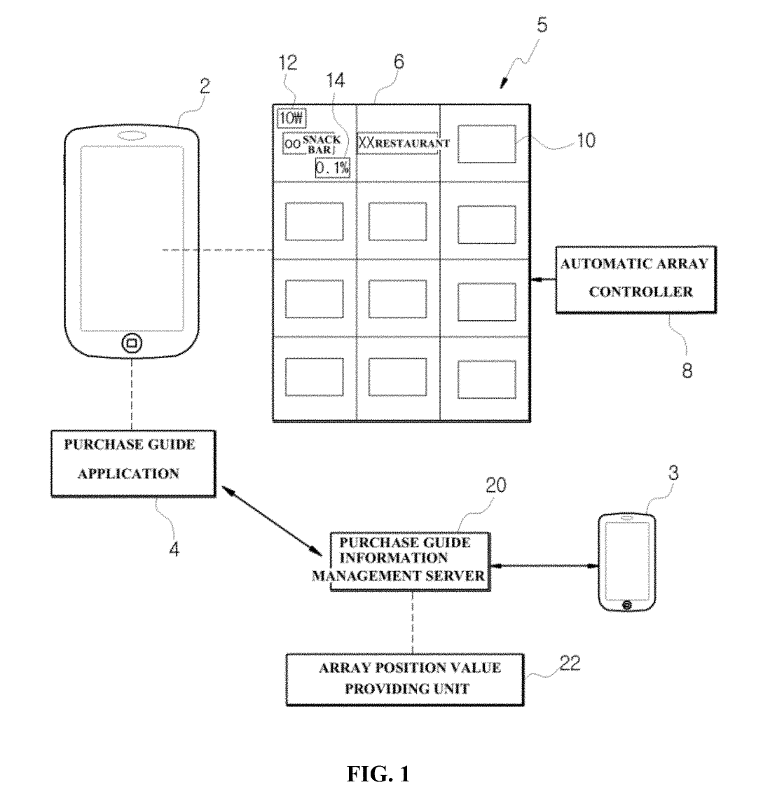

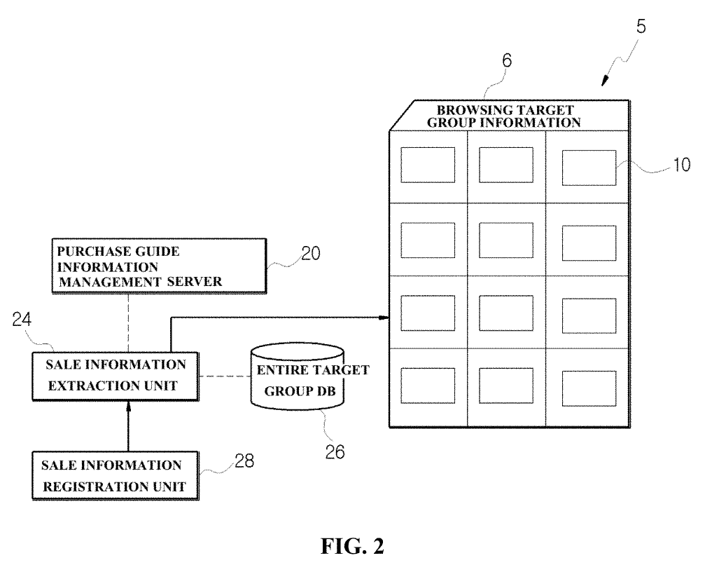

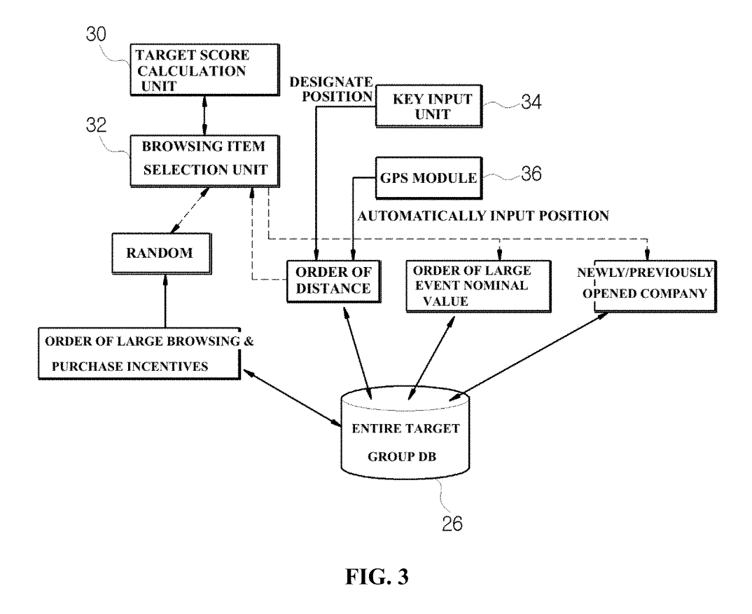

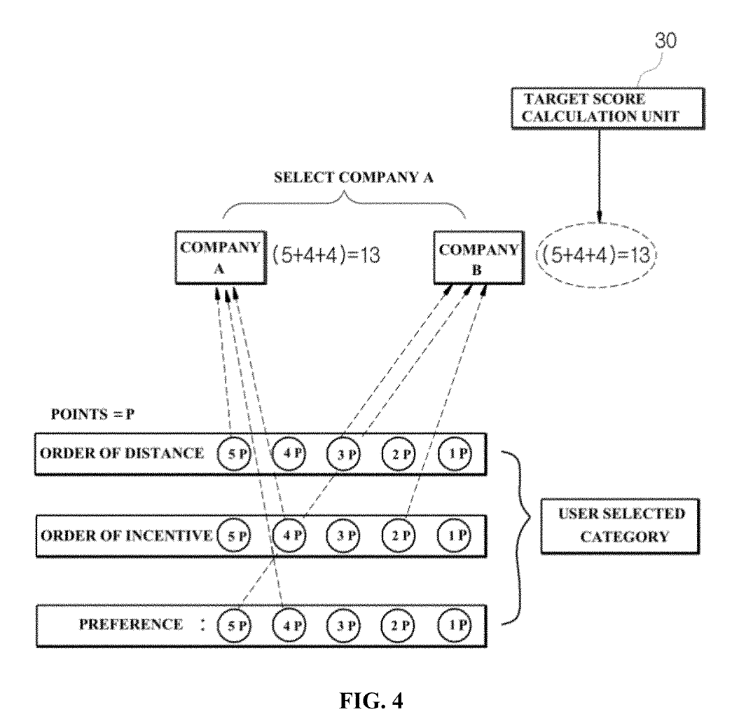

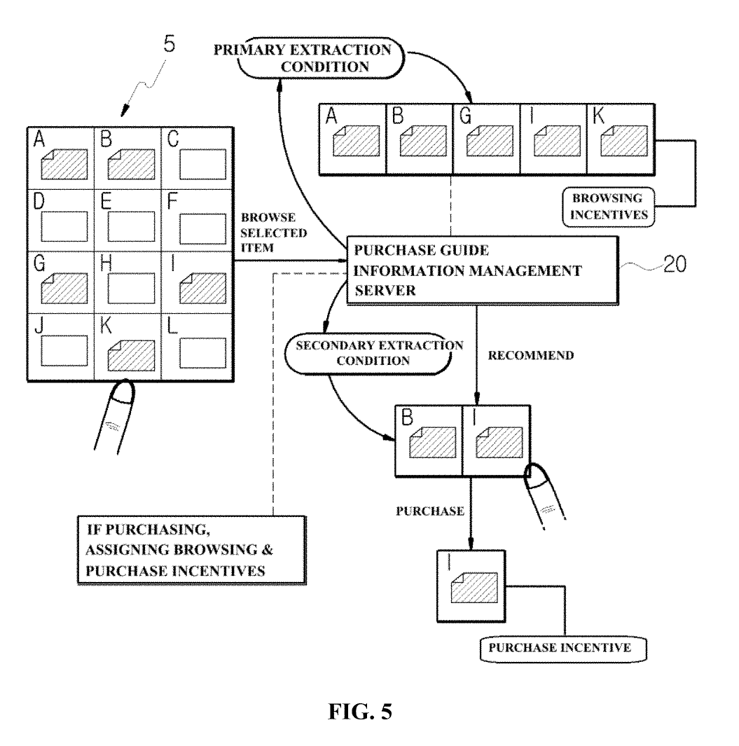

FIG. 1 is a diagram illustrating a configuration of the purchase guide information providing system mounted with intelligent selecting functions according to the embodiment of the present invention, FIG. 2 is a diagram illustrating a state in which company information is registered through the purchase guide information providing system mounted with intelligent selecting functions according to the embodiment of the present invention, FIG. 3 is a diagram illustrating a state of registering and processing browsing items included in the purchase guide information providing system mounted with intelligent selecting functions according to the embodiment of the present invention, FIG. 4 is a diagram illustrating a state in which scores to be extracted are calculated through the purchase guide information providing system mounted with intelligent selecting functions according to the embodiment of the present invention, and FIG. 5 is a diagram illustrating a state of processing information in the purchase guide information providing system mounted with intelligent selecting functions according to the embodiment of the present invention.

Referring to FIGS. 1 to 5, the purchase guide information providing system mounted with intelligent selecting functions according to the embodiment of the present invention is a system in which, if a consumer selects a predetermined browsing item which is a minimum condition, a predetermined number of pieces of company information are automatically extracted in descending order of total point values of scores assigned to the browsing item and are provided to the consumer, and if a predetermined number of pieces of company information is browsed from among the extracted company information, a specific company of the browsed companies is recommended by a server, and if a product of the specific company is purchased by the consumer, browsing incentives pre-assigned by each of the browsed companies and purchase incentives pre-assigned by a selling company are processed so as to be provided to the consumer, such that great benefits are offered to the consumer over the input time spent.

That is, in the purchase guide information providing system mounted with intelligent selecting functions according to the embodiment of the present invention, when a consumer selects a desired browsing item from among a plurality of browsing items, scores assigned to each browsing item are added up for each company.

Then, a predetermined number of pieces of company information is extracted from the highest score in descending order, and the extracted information is transmitted to the consumer. Therefore, by assigning scores to each company for each browsing item and adding up the scores, the consumer may save a time required to extract the company information having a large total point value.

The consumer may browse a predetermined number of companies provided by the server. The purchase guide information providing system mounted with intelligent selecting functions according to the embodiment of the present invention helps the consumer so as to easily make a purchase decision by recommending companies that meet predetermined recommend conditions among the companies browsed by the consumer.

In this case, when the consumer purchases a product recommended by the system, the server provides browsing incentives to be assigned upon browsing the company information and purchase incentives generated due to the purchase of the product.

On the other hand, if the consumer does not purchase the product of the company recommended by the system, the server does not provide the browsing incentive and the purchase incentive to the consumer. Therefore, it is preferable for the server to recommend at least two or more companies to the consumer so that the consumer's will can be reflected in the purchase.

Since the system may determine details of previous sales, the company may efficiently prepare the sale of products.

To this end, the purchase guide information providing system mounted with intelligent selecting functions according to the embodiment of the present invention includes: a user terminal 2 in which a purchase guide application 4 is installed therein to generate a selection signal for browsing company information and a selection signal for purchasing a product; and a company terminal 3 configured to register sale information 10, browsing incentive information, and purchase incentive information to a purchase guide information management server 20 and receive result information from the purchase guide information management server 20.

In addition, the purchase guide information providing system mounted with intelligent selecting functions according to the embodiment of the present invention includes the purchase guide information management server 20 configured to provide registration information between the user terminal 2 and the company terminal 3 according to a presetting condition.

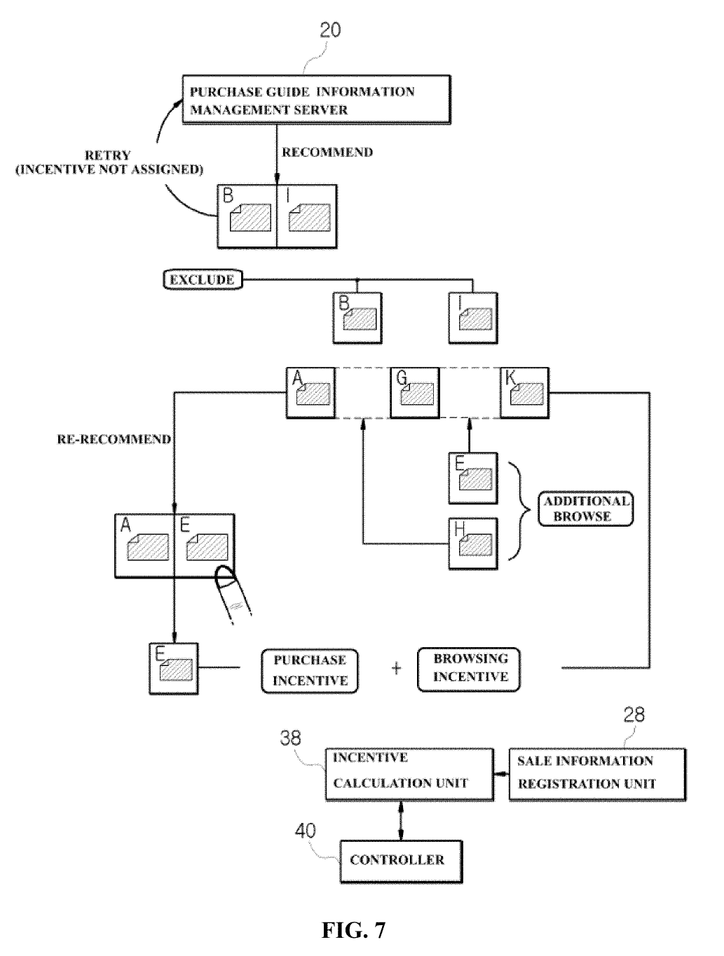

More specifically, the purchase guide information management server 20 includes: a sale information extraction unit 24 configured to, when receiving a browsing item selection signal from the user terminal 2, extract predetermined browsing target group information 5 that meets a preset extraction condition to transmit the extracted information to the user terminal 2; and a controller 40 configured to receive a browsing signal for specific companies from the user terminal 2, recommend a predetermined company among browsing companies based on a preset selection condition, and when a purchase confirmation signal for any one company of the recommended companies is generated, provide the browsing incentive and the purchase incentive to the user through the user terminal (see FIG. 7).

At this time, the browsing target group information 5 extracted and generated by the purchase guide information management server 20 is an information group in which a plurality of pieces of company information are sorted and arrayed in a matrix. The company information includes the sale information 10, browse incentive information 12, and purchase incentive information 14 displayed in an array frame 6.

The user terminal 2 includes an automatic array controller 8 installed therein to sort and array the browsing target group information 5 received from the purchase guide information management server 20. The purchase guide information management server 20 includes an array position value providing unit 22 configured to provide array position values of information included in the browsing target group information 5.

Therefore, the automatic array controller 8 and the array position value providing unit 22 share output position information of the company information, such that the purchase guide information management server 20 may determine a position where the company information is exposed in the user terminal 2, and company information selected by the user at the time of selecting the company information.

Meanwhile, the purchase guide information management server 20 further includes: a sale information registration unit 28 configured to register the sale information 10, the browsing incentive information 12, and the purchase incentive information 14 by the seller; and an entire target group DB 26 configured to store entire extraction target group information including the sale information 10, the browsing incentive information 12, and the purchase incentive information 14.

At this time, the sale information 10 is information hyperlinked so as to receive detailed sale information from the purchase guide information management server 20. When the user clicks the sale information 10 included in any one piece of company information among the pieces of company information output through the purchase guide application 4 of the user terminal 2, the purchase guide information management server 20 transmits the detailed sale information of the company registered in advance to the user terminal 2 to output the information on the screen thereof.

To this end, the purchase guide information management server 20 receives the sale information 10, the browsing incentive information, and the purchase incentive information from a plurality of companies, and registers the received information on the companies in the entire target group DB 26.

The user needs to generate a minimum selection signal in order to use the purchase guide information providing system mounted with intelligent selecting functions according to the embodiment of the present invention. To this end, the user may select a predetermined browsing item from among a plurality of browsing items.

The browsing items may be randomly arrayed, or may be arrayed by industry or by an order of distance, or by an order of large incentive or large event nominal value in descending order, and may include information on newly and/or previously opened companies. The user may select at least one or more browsing items through the purchase guide application 4.

That is, the browsing items are registered in the purchase guide information management server 20 according to search conditions of information desired by the consumer to browse. When the user selects a specific browsing item, only the company information that meets the browsing item may be displayed, and the user may browse the desired company information according to his or her will.

In addition, the purchase guide information management server 20 assigns scores to each browsing item for each company and registers them. Therefore, the user may extract information in a more advantageous manner.

For example, when the browsing items are arrayed in the order of ‘distance,’ if a company A located within 10 meters about a specific position receives 5 points, and a company B located between 20 meters and 30 meters receives 3 points, the company A is more likely to be extracted than the company B.

The importance with respect to the plurality of browsing items may be different for each user. Therefore, the purchase guide information providing system mounted with intelligent selecting functions according to the embodiment of the present invention is configured so as to extract a predetermined number of pieces of company information having the high assigned scores based on the browsing items selected by the consumer, as a primary extraction condition of information.

To this end, the purchase guide information management server 20 further includes: a browsing item selection unit 32 configured to receive a selection signal of at least one or more of browsing items selected by the user among entire browsing items; and a target score calculation unit 30 configured to extract a plurality of pieces of target information corresponding to the browsing items selected by the user from the entire target group DB6, and calculate scores assigned to each target information in order to further select a part of the pieces of the extracted target information.

In addition, a reference position for the company desired by the user to search may be a current position where the user is located, or may be a specific position designated by the user. When the reference position is the separately designated position, a means and a process for selecting or inputting the position are required.

For example, the current position where the user is located is Gangnam Station in Seoul, but if the place to go for dinner is Yeoksam Station adjacent thereto, it is convenient for the user to be recommended a company located near the Yeoksam Station for dinner. In this case, the user needs to input Yeoksam Station as the reference position of a company extraction target through the purchase guide application 4.

To this end, the user terminal 2 includes a key input unit 34 configured to generate a selection signal for browsing the company information and a selection signal for purchasing a product, and generate a position designation signal for requesting extraction of companies in an order of distance to a specific point; and a GPS module 36 configured to automatically determine the current position of the user.

Preferably, the purchase guide information management server 20 calculates the scores of the browsing items selected by the user for each company, extracts a predetermined number of pieces of company information in descending order from a company having a large total point value to form the browsing target group information 5.

This process is processed by the target score calculation unit 30 included in the purchase guide information management server 20. For example, when the user selects ‘order of distance,’ order of incentive,' or ‘preference’ among a plurality of browsing items, if a company A receives 5 points in the ‘order of distance’ browsing item, 4 points in the ‘order of incentive’ browsing item, and 4 points in the “preference” browsing item, the total point value thereof becomes 13 points.

In addition, when a company B receives 3 points in the ‘order of distance’ browsing item, 2 points in the ‘order of incentive’ browsing item, and 5 points in the ‘preference’ browsing item, the total point value thereof becomes 10 points. Therefore, it can be seen that the company A is more likely to be extracted by the purchase guide information management server 20 than the company B.

Meanwhile, the user may select a standard of the browsing target group information 5 that can be provided through the purchase guide application 4 of the purchase guide information providing system mounted with intelligent selecting functions according to the embodiment of the present invention. The standard of the browsing target group information 5 means the number of pieces of company information forming the browsing target group information 5.

In other words, the number of pieces of company information to be included in the browsing target group information 5 may be selected by the user, or may be set in the purchase guide information management server 20 in advance. Further, the purchase guide information management server may register number information and setting information on the company information to be included in the browsing target group information by matching with a user identification number.

When the user sets the number of pieces of company information to be included in the browsing target group information 5 in the purchase guide information management server 20 in advance, if the user selects only the browsing item, the purchase guide information management server 20 extracts only company information included in the set number of pieces of company information from a higher rank of the total point values of browsing items to form the browsing target group information 5.

When a predetermined number of pieces of company information are extracted and browsing target group information 5 is generated, the purchase guide information management server 20 transmits the browsing target group information 5 to the user terminal 2. Therefore, the user may click and browse the plurality of pieces of company information included in the browsing target group information 5.

At this time, preferably, when the user clicks a plurality of pieces of company information included in the browsing target group information 5, the purchase guide information management server 20 is set so as to limit the number of pieces of company information providing the browsing incentive to the user, in order to prevent the browsing incentives from being continuously provided to the user.

That is, it is preferable that the purchase guide information management server 20 increases the browsing incentive in response to the user's browsing signal until the number of pieces of company information reaches a preset number, and when reaching the preset number, limits the browsing incentive so as not to be increased even if further browsing the company information.

In addition, the purchase guide information management server 20 displays an upper limit for the number of pieces of company information providing the browsing incentives upon browsing the company information, such that the user allows to determine the number of pieces of company information to be browsed, which is advantageous to receive the browsing incentives.

The browsing target group information 5 provided to the user from the purchase guide information management server 20 is output on the screen of the user terminal through the purchase guide application 4. Therefore, as illustrated in FIG. 5, the user may click and browse a predetermined number of pieces of company information.

Of course, at this time, since the sale information 10, the browsing incentive information 12, and the purchase incentive 14 are displayed in each company information, the user determines a browsing target in consideration of each browsing incentive.

For example, when the user selects and browses companies A, B, G, I and K among a plurality of pieces of company information included in the browsing target group information 5, the browsing signal is transmitted to the purchase guide information management server 20 by the purchase guide application 4.

That is, when a user browses a plurality of companies through the primary extraction condition of information, which is an individual criterion of the user, the purchase guide information management server 20 recommends a predetermined number of companies among the browsed plurality of companies to the user. Further, the purchase guide information management server may recommend a predetermined number of companies to the user through a secondary extraction condition of information.

When a user purchases a product or service of the company recommended by the purchase guide information management server 20, the user may receive the browsing incentive and the purchase incentive. On the other hand, if a user browses the plurality of pieces of company information, but does not purchase the product or service of the company recommended by the purchase guide information management server 20, the user may not receive the browsing incentive and the purchase incentive.

The browsing incentives and the purchase incentives are different for each company, such that the user browses the company information in consideration of these differences. When the browsing of the company information is completed, the purchase guide information management server 20 recommends a predetermined number of companies to the user.

In this case, the purchase guide information management server 20 preferably recommends at least two companies, but may recommend a single company.

When the purchase guide information management server 20 recommends two or more companies, the user may receive the incentive only if the user purchases the product or service of one company of the two recommended companies.

For the recommendation, similarly to the process of extracting the browsing target group, the first user allows to select the browsing item.

In other words, the purchase guide information providing system mounted with intelligent selecting functions according to the embodiment of the present invention sets recommendation criteria of what company is recommended among the company information browsed by the user. According to the recommendation criteria, the user may use the preset browsing items.

Meanwhile, the purchase guide information management server 20 may recommend a company having the highest purchase incentive among the plurality of pieces of company information browsed by the user. The controller 40 of the purchase guide information management server 20 may process so that at least one newly and/or previously opened company is included in the recommended companies to be provided to the user.

At this time, the purchase guide information management server 20 provides browsing information of the user on the company information to the company terminal 3. An owner of a company (for example, an owner of an affiliate, etc.) may confirm the browsing information including a frequency of browsing the company information, may establish an additional marketing plan using the browsing information, and determine whether to change the browsing incentive or purchase incentive.

Next, the purchase guide information management server 20 may provide the browsing incentive and the purchase incentive to the user. At this time, the incentives are provided to the user when the user's purchase of the product or service of the company recommended by the purchase guide information management server 20 is confirmed.

The purchase of the user may be confirmed by the following two methods.

A first method is a method in which the user performs a payment in advance before purchasing a product or service of the company, and provides information on the prepayment to the purchase guide information management server 20 so as to be understood. Particularly, when the purchase guide information management server 20 can perform the payment function, it is possible to directly process the prepayment, so as to be more quickly determined whether the user purchases the product or service.

At this time, the purchase guide information management server 20 transmits the company information, the product information, and the payment information, which are prepayment targets, to the purchase guide application 4. An employee of the company may determine whether it is the prepayment target based on the transmitted identification information.

Meanwhile, in the first method, even if the user does not perform the prepayment, a preliminary payment signal is generated in the purchase guide information management server 20. At this time, after the purchase guide information management server 20 transmits preliminary payment identification information including the browsing incentive and the purchase incentive information, if the user actually presents the preliminary payment identification information to the employee of the company, the employee of the company may transmit the identification information to the purchase guide information management server 20 through the company terminal 3 to confirm a final payment amount and perform the payment.

In other words, the final payment amount is a payment amount reflecting the browsing incentive and purchase incentive.

A second method is a method in which, when receiving payment information and user information from the company terminal 3, the purchase guide information management server 20 provides the browsing incentive and the purchase incentive to the user.

In this method, the purchase guide information management server 20 receives the user's telephone number from the company terminal 3 to identify the user, and provides the browsing incentive and the purchase incentive to the user so as to use the incentives later.

At this time, the purchase guide information management server 20 may provide, to the terminal 3, information on the frequency of exposure of the company information included in the browsing target group information 5, information on what user has browsed the company information, and information on the frequency of recommendation of company information to the user.

Due to the information as provided above, when the company is excluded from the browsing target group, it is possible to determine the reason why the company is excluded from the browsing target group or excluded from the recommendation target by comparing the browsing incentive or the purchase incentive with other companies. Even if the company is included in the recommendation target, but the user does not purchase the product of the company, since the user has already browsed the company information, it is possible to consider performing an additional event targeting such a user.

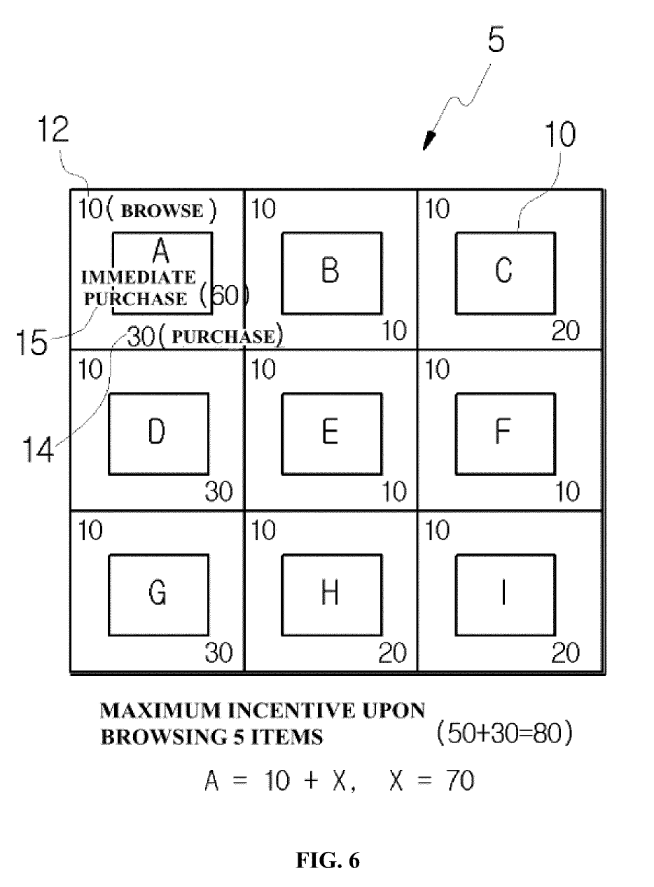

FIG. 6 is a diagram illustrating a state of processing an immediate purchase through the purchase guide information providing system mounted with intelligent selecting functions according to the embodiment of the present invention.

Referring to FIG. 6, the user generally compares a product to be consumed with products of other companies. However, if the user determines a brand of the product to be purchased, or the consumption of a specific product in advance, the user will want to purchase the specific product in such a state.

In this case, when recommending a product desired by the user to purchase through the system, if the product is excluded from the recommendation target, the user does not receive the browsing incentive and the purchase incentive.

In addition, it is necessary for the company that sells the products to implement a method to solve such a problem.

Therefore, when a user generates an immediate purchase signal in a state in which the user does not browse information of other companies, the purchase guide information providing system mounted with intelligent selecting functions according to the embodiment of the present invention additionally provides an immediate purchase incentive to be provided to the user.

That is, the sale information registration unit 28 may further register conditional and additional incentive information on the immediate purchase in which the user purchases the product without browsing other companies. The purchase guide information management server 20 separately registers and displays the immediate purchase incentive to be provided to the user at the time of the conditional purchase which requires the product to be purchased without browsing other companies.

For example, assuming that the number of browsing allowed in the purchase guide information providing system mounted with intelligent selecting functions according to the embodiment of the present invention is limited to 5, the browsing incentives are 10, which are all the same as each other, while the purchase incentives may be different from each other for each company.

In this case, upon browsing five companies and purchasing a product of the recommended company of them, the user may receive 80 as the incentive which is a value of adding 30 to 50 of the incentive maximum value that can be obtained by the user.

That is, in this case, to allow the user to receive the same incentive of 80 through the immediate purchase, the owner of the company should offer 70 as the immediate purchase incentive.

However, there may be a case in which, even if the owner of the company did not provide the immediate purchase incentive of 70, a user who selected the immediate purchase has a strong will to purchase the product of the company. Thereby, it is highly possible that the user purchases the product even when the owner of the company offers an immediate purchase incentive that is somewhat smaller than 70.

Meanwhile, as illustrated in FIG. 6, the number of companies that can be browsed by the user is about 9, but it is also possible to select the product based on the brand alone without comparing the companies. In this case, if 100 or 150 of immediate purchase incentive which is higher than 80, among two or three brands desired by the user is offered, the user will be able to actively participate in the immediate purchase of the products.

FIG. 7 is a diagram illustrating a state of processing a re-recommendation request through the purchase guide information providing system mounted with intelligent selecting functions according to the embodiment of the present invention.

Referring to FIG. 7, the purchase guide information management server 20 included in the purchase guide information providing system mounted with intelligent selecting functions according to the embodiment of the present invention is configured, when receiving a company re-recommendation request signal from a user through the user terminal 2, to impose a penalty on the user.

That is, the purchase guide information management server 20 recommends a predetermined number of companies. In this regard, it is preferable that the purchase guide information management server 20 recommends at least two or more companies, but the server may recommend a single company.

In the purchaser guide information management server 20, it may be assumed that the user browses “companies A, B, G, I and K” among the browsing target group information 5, and the purchase guide information management server 20 extracts a plurality of companies (for example, the companies B and I) among the five companies browsed by the user to recommend the extracted companies to the user.

In this state, when purchasing a product of any one company (for example, the company B) among the plurality of companies recommended by the purchase guide information management server 20, the user may receive a browsing incentive (a sum of the browsing incentives provided by the companies A, B, G, I and K), and a purchase incentive (the purchase incentive provided by the company B).

At this time, the controller 40 performs the calculation of the incentives, but may include an additional incentive calculation unit 38 to separately calculate the incentives.

However, in a case in which the user does not intend to purchase the product or service sold by the companies (for example, the companies B and I) recommended by the purchase guide information management server 20, the user may generate a company re-recommendation request signal.

In this case, the purchase guide information management server 20 may impose a penalty on the user.

For example, the purchase guide information management server may impose a penalty on the user so as to browse the same number of additional company information as the recommended companies. The reason is that the companies B and I, which are recommended for the first time, are excluded from the recommendation target.

As another method of imposing a penalty, the incentive may be subtracted by a certain ratio, not providing all the incentives that can be received by the user. Preferably, the incentive is not subtracted by a certain ratio at the time of one re-recommendation request, and the incentive is subtracted by the certain ratio at the time of a next re-recommendation request.

In addition, the user may request the re-recommendation two or three times. In this case, preferably, the ratio of incentive to be subtracted is further increased.

When the user browses information of companies E and H, the browsed companies become the companies A, H, G, E and K, and the purchase guide information management server 20 again recommends a plurality of companies among the browsed companies.

Then, the purchase guide information management server 20 may recommend two companies of the browsing target companies, for example, the companies A and E, based on the recommendation condition. When the user purchases a product of the company E, the purchase guide information management server 20 provides an incentive by adding up the browsing incentives of the companies A, G, H, G, E and K, and the purchase incentive of the company E.

Through this process, in accordance with the purchase guide information providing system mounted with intelligent selecting functions and the method thereof according to the present invention, it is possible to recommend a company having the most favorable condition to the user who takes the least amount of time, and in this process, recommend a small number of companies by compressing the results. Thus, a user who has to spend a lot of time in purchasing decisions, or who inevitably has to spend a lot of time to find the most favorable condition may make a purchase decision in a very efficient and convenient manner. In addition, since the sellers may intensively use marketing costs on the user who actually makes the purchase, it is possible to obtain marketing effects greater than ever before.

Meanwhile, the purchase guide information providing system mounted with intelligent selecting functions according to the embodiment of the present invention is not limited to the above-described embodiments but may be variously changed without departing from the technical scopes thereof.

### DESCRIPTION OF REFERENCE NUMERALS

2: User terminal

4: Purchase guide application

5: Browsing target group information

6: Array frame

8: Automatic array controller

10: Sale information

12: Browsing incentive information

14: Purchase incentive information

20: Purchase guide information management server

1. A purchase guide information providing system mounted with intelligent selecting functions, the system comprising: a purchase guide information management server 20 which comprises:
a sale information extraction unit 24 configured to, when receiving a browsing item selection signal from a user terminal 2, extract predetermined browsing target group information 5 that meets a preset extraction condition to transmit the extracted information to the user terminal 2; and
a controller 40 configured to receive a browsing signal for specific companies from the user terminal 2, recommend a predetermined company among browsing companies based on a preset selection condition, and when a purchase confirmation signal for any one company of the recommended companies is generated, provide a browsing incentive and a purchase incentive to a user through the user terminal.

2. (canceled)

3. The system according to claim 1, wherein the user terminal 2 comprises an automatic array controller 8 installed therein to sort and array the browsing target group information 5 received from the purchase guide information management server 20.

4. The system according to claim 1, wherein the browsing target group information 5 is information in which a plurality of pieces of company information including sale information 10, browsing incentive information 12, and purchase incentive information 14 are sorted.

5. The system according to claim 1, wherein the purchase guide information management server 20 comprises an array position value providing unit 22 configured to provide array position values of information included in the browsing target group information 5.

6. The system according to claim 1, wherein the purchase guide information management server 20 further comprises:
a sale information registration unit 28 configured to register the sale information 10, the browsing incentive information 12, and the purchase incentive information 14 by a seller; and
an entire target group DB 26 configured to store entire extraction target group information including the sale information 10, the browsing incentive information 12, and the purchase incentive information 14.

7. The system according to claim 1, wherein the browsing items are randomly arrayed, or are arrayed by industry or by an order of distance, or by a size of incentive or an event nominal value in descending order, and include information on newly and/or previously opened companies.

8. The system according to claim 1, wherein the purchase guide information management server 20 further comprises:
a browsing item selection unit 32 configured to receive a selection signal of at least one or more of browsing items selected by the user among entire browsing items; and
a target score calculation unit 30 configured to extract a plurality of pieces of target information corresponding to the browsing items selected by the user from the entire target group DB6, and calculate scores assigned to each target information in order to further select a part of the pieces of the extracted target information.

9. The system according to claim 1, wherein the user terminal 2 comprises a key input unit 34 configured to generate a selection signal for browsing company information and a selection signal for purchasing a product, and generate a position designation signal for requesting extraction of companies in an order of distance to a specific point; and
a GPS module 36 configured to automatically determine a current position of the user.

10. The system according to claim 1, wherein the purchase guide information management server 20 is configured to recommend a plurality of companies to the user terminal 2.

11. The system according to claim 1, wherein the purchase guide information management server 20 is configured to provide browsing information of the user on the company information to a company terminal 3.

12. The system according to claim 1, wherein the purchase guide information management server 20 is configured to transmit recommendation information of the company for the user, and preliminary purchase information of the user on the company information to a company terminal 3.

13. The system according to claim 1, wherein, when receiving a prepayment signal from a purchase guide application 4, the purchase guide information management server 20 is configured to provide a browsing incentive and a purchase incentive to the user through the user terminal; and
the purchase guide information management server 20 is configured to transmit company information, product information, and payment information, which are prepayment targets, as identification information that can be determined by the company, to the purchase guide application 4.

14. The system according to claim 1, wherein the purchase guide information management server 20 is configured to receive information on a user who has purchased a product from a company terminal 3 and provide a browsing incentive and a purchase incentive to the user.

15. The system according to claim 1, wherein the purchase guide information management server 20 is configured, when receiving a company re-recommendation request signal from a user through the user terminal 2, to impose a penalty on the user.

16. The system according to claim 1, wherein, when receiving a company re-recommendation request signal from the user terminal 2, the purchase guide information management server 20 again forms the browsing target group information 5 so that the user further browses the same number of companies as the number of the recommended companies.

17. The system according to claim 1, wherein the controller 40 processes so that at least one newly and/or previously opened company is included in the recommended companies to be provided to the user through the user terminal.

18. The system according to claim 1, wherein the purchase guide information management server 20 receives number information and setting information on the company information to be included in the browsing target group information 5 from a purchase guide application 4, and registers the received information by matching with a user identification number.

19. The system according to claim 1, wherein the purchase guide information management server 20 is set so as to limit the number of pieces of company information providing the browsing incentive to the user.

20. The system according to claim 4, wherein the sale information 10 is information hyperlinked so as to receive detailed sale information from the purchase guide information management server 20.

21. The system according to claim 6, wherein the sale information registration unit 28 processes so as to further register conditional and additional incentive information on an immediate purchase in which a user purchases a product without browsing other companies.

22-30. (canceled)
